(19) United States
(12) Patent Application Publication
(10) Pub. No.: US 2022/0128032 A1
(43) Pub. Date: Apr. 28, 2022

(54) HORIZONTAL-AXIS TURBINE FOR A WIND GENERATOR, AND WIND GENERATOR COMPRISING SAID TURBINE

(71) Applicant: Energietiche Srl, Rimini (IT)

(72) Inventors: Carlo Alberto CIMATTI, Forli (IT); Daniele MARIAN, Ravenna (IT)

(73) Assignee: Energietiche Srl, Rimini (IT)

(21) Appl. No.: 17/442,930

(22) PCT Filed: Mar. 25, 2020
(86) PCT No.: PCT/IB2020/052797

§ 371 Date: Sep. 24, 2021

(30) Foreign Application Priority Data
Mar. 26, 2019 (IT) 102019000004325

(51) Int. Cl. F03D 9/25; H02K 7/18

(52) U.S. Cl. CPC F03D 9/25; F05B 2240/221; H02K 7/183

(57) ABSTRACT

Horizontal-axis turbine for a wind generator, the turbine comprising a hub and two opposed blades, the turbine being characterized in that:

said hub is adapted to be directly or indirectly connected to a supporting pole (P) of the wind generator, and comprises a rotary part (M2), to which said two blades are connected;
said two blades are elongate in a longitudinal direction operationally orthogonal to the central axis of rotation (A) of the turbine,
each one of said two blades comprises a wing (A1, A2) and a deflector (D1, D2) fixedly connected to said rotary part (M2), the wing and the deflector having a head and a tail, the deflector tail being proximal to the wing head,
the deflector is positioned ahead of the respective wing with respect to the direction of rotation of the turbine, so as to deflect the air flow towards the wing,
the tail of each deflector is spaced apart from the head of the respective wing, so as to define a gap (L1, L2) between the deflector and the wing,
the wing and the deflector of each one of said two blades are connected at their outermost ends by a connection element (F).

### TECHNICAL FIELD

The present invention relates to a horizontal-axis turbine for a wind generator, and to a wind generator that comprises said turbine.

The present invention finds application in the turbomachine field, and in particular in the wind turbine field.

The present invention finds a particularly advantageous application for micro aeolian machines, in particular horizontal-axis wind turbines.

### BACKGROUND ART

The wind turbines known in the art typically comprise a supporting structure and a rotor. The rotor comprises at least one blade, coupled to the supporting structure for rotating about an axis of rotation. Said axis of rotation may be oriented either parallel or perpendicular to a wind incidence direction, hence the distinction between horizontal-axis wind turbines (also known as HAWTs) and vertical-axis wind turbines (also known as VAWTs). The present description concerns a horizontal-axis wind turbine, i.e. a wind turbine wherein the axis of rotation of the rotor is parallel to the wind incidence direction.

In HAWT turbines, the blades rotate about an axis of rotation (i.e. the central axis) that is perpendicular to a direction along which the blades elongate.

According to the different relative position of the rotor and of the supporting tower, horizontal-axis wind generators can be divided into UPWIND and DOWNWIND turbines.
UPWIND turbines: most horizontal-axis turbines throughout the world are of this type. In these turbines, the wind flow first encounters the rotor, then flows around the hub (the turbine bulb), and finally moves on. They require a mechanism for orienting the blade in the wind direction.
DOWNWIND turbines: they are much less widespread than upwind turbines, and practically operate in the opposite manner. In these turbines, the wind first flows around the hub, then hits the rotor and finally moves on. They do not require a mechanism for orienting the blade in the wind direction, but part of the wind blows onto the blades after having crossed the hub; therefore, the flow is disturbed.

In a wind generator a conversion generally occurs from aerodynamic energy to mechanical energy, and then from mechanical energy to electric energy.

During each conversion, the quantity of energy transmitted is always less than it was at the beginning of the transformation. However, while losses due to the mechanical components, the aerogenerator and the adaptation to the electric grid, are small, the aerodynamic-mechanical conversion has an ideal maximum efficiency, defined by Betz's theory, which amounts to approximately 59%.

Such limit establishes that the theoretical maximum energy of a cylindrical air flow convertible from aerodynamic to mechanical is 16/27 of the input energy.

Thus, assuming that Betz's hypothesis is true, the aerodynamic power P that can be extracted from a fluid vein is expressed by the following relation:

P=½ρCpSν³

where:
ρ is the air density;
Cₚ is the power coefficient, which is a parameter that quantifies aerodynamic efficiency, i.e. the ratio between the mechanical power that the turbine can produce and the power associated with the wind;
S is the equivalent surface swept by the turbine blades;
ν is the wind speed.

The fluid vein that hits the profile, schematized as the apparent wind vector Vr (FIG. 1), is the vectorial combination of the external wind speed Vv and the blade advance speed Vp (changed in sign) during its rotation.

The angle of attack α is the angle between the apparent wind Vr and the profile speed Vp and, assuming that the external wind Vv is constant, it increases as the speed Vp decreases, according to the speed triangle.

In a horizontal-axis wind turbine, since

Vp=ωR

where
ω angular profile speed
R turbine radius
assuming that Vv is constant, the intensity and angle of attack of Vr vary with the diameter; in particular, intensity increases and the angle decreases towards the periphery.

The apparent speed Vr generates on the profile, according to the known aerodynamics principles, a resultant force Fp, which is vectorially composed of two components (FIG. 2):
LIFT: aerodynamic lift Fl, orthogonal to the direction of the fluid vein;
DRAG: aerodynamic drag Fd, parallel to the direction of the fluid vein.

However, as regards the operation of the turbine, it is of interest to break up the resultant of the aerodynamic forces Fp in two other directions:
F∥ propulsive component of the aerodynamic force, parallel to Vp;
F⊥detrimental component of the aerodynamic force, orthogonal to Vp.

For each wing cross-section, speed and force triangles can be drawn which are similar to the one expressly described above.

The propulsive aerodynamic force F∥ on a profile is thus generated through the effect of the angle of attack α, and is a component of aerodynamic lift, according to the profile advance direction.

In mathematical terms, lift and drag can be written as:

Fl=Cl×S×½ρ×Vr²

Fd=Cd×S×½ρ×Vr²

where:
Cl lift coefficient
Cd drag coefficient
S surface
ρ air density
Vr speed of the fluid vein (apparent wind for HAWTs)

The efficiency E of a wing profile is given by the ratio between lift and drag:

E=Fl/Fd

or

E=Cl/Cd

(since all other values are common to both formulas)

A fundamental characteristic of lift is that it rapidly falls with angles of attack α typically exceeding 15-20° (depending on the profile), because the fluid threads detach from the back of the aerofoil. As α further increases, drag increases without any beneficial effects on lift, which will tend to go down rapidly to zero, and so will the profile's efficiency.

This phenomenon is known as aerodynamic stall.

Similarly, with very small angles of attack lift decreases again (until it becomes null when α=0, for symmetrical profiles), while drag takes a minimum value different from zero and strongly related to the shape and surface finish of the profile.

It is therefore clear that every profile has its own optimal value for the angle of attack α, which maximizes the lift value: Cl (and hence Fl) grows progressively as the angle of attack increases, up to the point of maximum lift; beyond such angle, Cl (and hence Fl) decreases a little and then the curve stops because lift falls sharply to zero and stall occurs.

Also Cd (and hence Fd) grows, although differently, as the angle of attack increases, but it does not start from zero, because a moving body always generates some minimal resistance.

The values of Cl and Cd can be represented graphically as a function of α (FIG. 3).

By putting the relation between Cl and Cd into a single diagram, the characteristic curve of an aerofoil as a function of α is obtained, which is referred to as aerofoil polar (FIG. 4).

Each polar refers to a given profile speed or, better still, to a given Reynolds number, which also involves the dimensional characteristics of the wing (through the chord thereof), the air density, and the speed at which the wing is moving (or is being hit by the air flow, according to the principle of effect mutuality).

By reading this very important graph it is possible to understand which is the optimal angle of attack α of an aerofoil for a specific use, i.e. the value of a that maximizes its efficiency at a given speed. As far as horizontal-axis wind turbines are concerned, therefore, in order to maximize their efficiency, the apparent wind Vr should ideally maintain this value of a in any profile section and at any profile speed Vp and external wind speed Vv.

Since α is the angle between (−Vp) and Vr, it is inversely proportional to the ratio between Vp and Vv, called TSR (Tip Speed Ratio).

In the case of horizontal-axis turbines, as aforesaid, Vp is proportional to the radius (being null at the centre and highest at the periphery); typically TSR is referred to the speed of the blade tip.

TSR is therefore a fundamental parameter, because each wind turbine is characterized by a so-called “power curve”, wherein, for a given wind speed, Cp (power coefficient) is related to TSR.

Such diagram is built by changing the TSR value, i.e. by progressively braking the turbine and measuring the corresponding power output, until the TSR value that maximizes Cp is identified, which will become the nominal TSR of the turbine.

Said curve is the reference for the exploitation of the energy produced by means of a given work machine.

Also, the “solidity” parameter is defined as the ratio between the total surface of the blades and the projection of the area swept by the turbine blades on the plane orthogonal to the wind direction. Tendentially, the nominal TSR value (i.e. the TSR value at which the highest Cp is obtained) decreases as solidity increases.

Typically, the efficiency of aeolian machines increases when they are designed for high TSR values, i.e. when they are characterized by low solidity.

It can therefore be stated that, as solidity decreases, the efficiency of the machine will tendentially increase, but at the same time self-starting will become more difficult and the wind cut-in speed will increase (i.e. the wind speed at which the aerogenerator will start producing energy).

Two-bladed machines have absolute efficiencies higher than three-bladed ones, but at the price of greater starting difficulty (higher cut-in winds) and higher TSR values, which translate into higher noise and structural problems.

This is the reason why the most widespread machines in the world are three-bladed ones: the three-bladed configuration represents the best trade-off between the goal of not perturbing the air flow too much (which should remain as laminar as possible) and the capability of generating high Cp values at lower TSRs.

In general, the curves of machines with high Cp values are characterized by low efficiency when they operate with TSRs that are distant from the design value.

In particular, this characteristic translates into the necessity of operating HAWTs at very high speeds to ensure optimal TSR values, usually around 6-8 for three-bladed HAWTs and around 10-12 for two-bladed HAWTs, as can be seen in the graph of FIG. 5, which schematizes the power curves Cp that are typical of the most common types of wind turbines as a function of TSR.

In FIG. 5, the curve 51 represents the ideal trend of Cp (which would correspond to an infinite number of blades); the curve 52 represented the trend of Cp of a Savonius turbine; the curve 53 represents an American turbine; the curve 54 represents a windmill; the curve 55 represents a Darrieus turbine; the curve 56 represents a three-bladed turbine; the curve 57 represents a two-bladed turbine; the curve 58 represents a single-bladed turbine.

However, the increased speed of the turbine blades leads to increased noise, due to the presence of wingtip vortices and “draft resistances” and to the fact that the noisiness of aeolian machines is associated with the pressure waves caused by the profile passing through the fluid vein at high speed. The smaller the turbine diameter, the higher the frequency of such waves, because the number of revolution increases, the angular velocity being the same.

Therefore, noisiness becomes a major problem for micro aeolian machines, which are characterized by small diameters (with power ratings of the order of a few hundreds of Watts) and very high rpm, wherein the frequency is so high as to generate a hissing sound so loud as to prevent use in inhabited areas or for any application requiring the presence of people (e.g. boats, caravans, etc.).

A lower TSR would automatically imply a noise reduction.

However, lowering the TSR requires the creation of wing architectures capable of producing high torque at low speed, and this implies the following:
High Reynolds numbers; however, Vr being low, the only possibility left is to increase the profile chord, and hence

Large wing surfaces S(F=½×S×CT×Vr²)
Efficient profiles capable of not stalling even at wide angles of attack, so as not to lose aerodynamic efficiency
Small number of blades, to avoid aerodynamic interference between the same, while still providing high efficiency.

The horizontal-axis micro wind turbines currently available on the market do not offer the simultaneous presence of all these features.

Another very important aspect that concerns all aeolian machines is the problem of braking at high wind speeds.

Typically, once the rated power of the turbine has been reached, it will remain constant up to the maximum wind speed threshold tolerated by the machine (cut-out speed). Beyond this threshold, aerogenerators will stop producing energy and will go into safety mode through the use of active or passive protection systems that will lead to:
full rotor stop;
misalignment between blade rotation axis and wind direction.

Micro aerogenerators mostly utilize the latter solution, because it is a passive mechanism that does not require the presence of complex electromechanical devices; quite simply, when the cut-out speed is reached, the rotor will rotate, thanks to the presence of a “hinge”, vertically about its own axis, thus losing its orthogonality relative to the wind direction, resulting in abated aerodynamic efficiency and propulsive capability of the blades.

The rotation of the turbine about its own axis is referred to as yaw.

By controlling yaw it is also possible to optimize the power produced.

Yaw control and adjustment systems may be:
active: these sophisticated servomechanisms, controlled by anemometers and processors, ensure optimal alignment between the rotor axis and the wind direction (due to their high cost, however, they are only used in medium-to-large turbines);
passive: for orienting the nacelle according to the wind direction, small turbines are equipped with a simple directional vane.

In order to optimize the power output as wind speed varies, two types of power control systems also exist:
pitch control: the blades rotate about their own axis to adjust the angle of attack of the aerofoil and thus modify the aerodynamic efficiency of the blades;
stall control: the blades do not rotate about their own axis, since they are constrained to the hub, but the helix geometry is aerodynamically designed in a manner such that, when the wind speed becomes too high, turbulences will be created to counter the thrust exerted on the blades. This is a passive type of power control. The main advantage of the latter type of control is its simplicity, because it makes it possible to eliminate many of the components that would otherwise be necessary for an electronic control system.

Another problem that affects wind turbines, particularly horizontal-axis ones, is the fact that they operate most of the time in the presence of a highly unstable environmental inflow.

The effects of aerodynamic instability that must be taken into account for wind turbines are:
speed of the wind, which is variable in direction and intensity: the wind seldom blows at constant speed, and shows continual direction fluctuations, which induce frequent variations in the angle of attack on the blades;
wind speed gradients: wind turbines operate in a stratified atmosphere with considerable speed gradients. This produces another cause of non-uniformity in the angle of attack of the blades of big machines, resulting in instability thereof;
tower shadow effects: particularly for DOWNWIND turbines, the passing of the blade behind the tower, or “shadow”, implies transient changes in the angle of attack on the blade elements. An adequately slim support may reduce such adverse consequences.

All these phenomena considerably reduce the production capacity of wind turbines because the variations in the angle of attack induce the profile to work in low-efficiency conditions, considering that, as previously explained, each profile has a specific value of a at which it provides maximum lift, outside of which the latter will decrease drastically, and so will the propulsive capability of the wing and the overall efficiency of the turbine.

### SUMMARY OF THE INVENTION

It is the object of the present invention to provide a turbine for a horizontal-axis wind generator and a wind generator comprising said turbine, which are adapted to overcome the above-mentioned drawbacks of the prior art.

The horizontal-axis turbine for a wind generator of the present invention is particularly simple, economical, efficient and reliable.

The turbine is structured in such a way as to make self-starting possible with minimal cut-in wind, ensuring high efficiency in all conditions of use with TSR values considerably lower than prior-art turbines; it is therefore characterized by very low noise and low environmental impact, and it is both less dangerous and easier to brake when cut-out wind is reached.

In the invention proposed herein, the above problems are not solved by looking for an aerofoil having an extremely sophisticated shape capable of simultaneously fulfilling all of the above-mentioned requirements (which, by the way, does not exist), but by using a pair of “standard” profiles cooperating with each other to maintain lift, and hence propulsive thrust, even with very wide and variable angles of attack of the fluid vein, thus making the turbine less sensitive to sudden wind oscillations and hence capable of always obtaining the maximum possible effective thrust and maximizing overall energy production.

As aforesaid, therefore, the wing is composed of a pair of profiles, one of which precedes the other in the direction of forward motion of the wing.

The two profiles are so positioned as to interact and collaborate with each other to overcome the inherent limitations of a single wing.

The choice of the two profiles and of the mutual positioning thereof is dictated by the following logic:
the leading wing must be a profile capable of working with good efficiency without stalling even at rather high and variable angles of attack; therefore, it must not necessarily be a profile offering extremely high performance at high speeds, but rather a versatile profile providing considerable “drive” in a broad range of conditions
the trailing wing must be a high-performance profile capable of ensuring high efficiency for certain values of the angle of attack, without necessarily having to be capable of working at wide and variable angles of attack;
the two profiles must have aerodynamically matching shapes, and their mutual positioning must be such as to enhance their cooperation, so that the overall efficiency of the pair of profiles exceeds the sum of the efficiencies of the single profiles.

In operation, the first profile blows onto the second one, so that the outflow will be accelerated and deviated with the optimal angle of attack for the second profile and, through the Coanda effect, will remain adherent thereto, thus causing it to be, de facto, always fully active.

In this way the first profile, which is more versatile and able to “attack” the wind with wide and variable angles of attack, will always be capable of exerting a drive force, while at the same time deviating the flow onto the trailing profile, which will then work at about its own optimal angle of attack and always provide the maximum possible propulsion.

The horizontal-axis turbine for a wind generator of the present invention also has another feature that distinguishes it from any other turbine type known in the art.

As aforesaid, it stems from the need to solve the above-mentioned problems that affect wind turbines, in particular those of very small size, and must therefore fulfil a fundamental requisite, i.e. being as small as possible.

Starting from this assumption, it is immediately apparent that it is necessary to exploit the whole area swept by the rotor, and it is therefore impossible to adopt the architecture that is typical of prior-art horizontal-axis wind turbines, wherein the area occupied by the hub (and disturbed by its presence) and by the terminal part of the blades where they attach to the hub (root) are not exploited for propulsive purposes.

Typically, in this region the blade loses its propulsive function, and its profile changes, assuming a shape that is dictated more by structural, rather than aerodynamic, requirements.

During the rotation, the hub and the wing root occupy a circular sector that, particularly in very small machines, may constitute up to 30% of the effective swept area.

As aforementioned, one of the features of the present invention lies in the fact that dimensions are kept as small as possible; therefore, the proposed wind turbine is able to exploit also this central zone, thanks to the particular architecture of the blades and the hub, which can interact and cooperate with each other, thus becoming a fundamental part with a view to increasing the overall efficiency of the turbine.

These two elements take such a shape that realizes a wholly innovative collaboration.

The blades of the proposed turbine have a chord that progressively increases from tip to root, where they wind themselves around a hub having an aerodynamic shape studied for accelerating and conveying the flow onto the blades.

In this way, all the area swept by the rotor is active and contributes to energy production.

The region near the axis of rotation operates at TSR values lower than one but, due to the large wing surfaces, to the particular aerodynamic configuration adopted (with the wings winding themselves around the hub, and the hub conveying the flow onto the wings), and to the cooperation between the profiles that constitute the wings, it becomes a part that facilitates self-starting at minimum cut-in winds and exploitation of all low-wind conditions, as well as a sort of flywheel capable of absorbing continual wind oscillations (in intensity and direction) and of always ensuring sufficient torque to keep the peripheral and better performing regions of the blades in optimal TSR, and hence production, conditions.

The following will explain the basic concept of this architecture.

An aerofoil hit by a fluid vein shows, as aforesaid, a behaviour which is described by its polar and which is strictly related to its dimensional characteristics and to fluid speed.

These two quantities appear in the so-called Reynolds number:

Re=kvl

where:
k constant (taking into account fluid viscosity and density)
v fluid speed in m/s
l profile chord in m

It is evident that Re increases linearly with fluid speed and profile length.

Typically, as Re increases the efficiency of a profile increases and its polar becomes more and more regular and less and less sawtooth shaped.

Within the field of micro wind turbines, Re takes values typically lying in the range of 0 to 1,000,000. These are very low values for common wing profiles; in addition, these values are obtained because of the extremely high revolution speed, rather than because of the dimensions of the wings, which, being typically more than three, must be very slim to avoid increasing solidity too much to detriment of efficiency.

It is apparent that any wing profile will hardly be able to ensure satisfactory performance, particularly in low-wind conditions, when Re values may easily tend to zero.

In such conditions, no aerofoil can produce propulsion; as a consequence, the actual cut-in values of horizontal-axis micro wind turbines according to the prior art are very high, because the small blades cannot cause the generator to produce energy until Re reaches a minimum value, which is only obtained at high fluid speeds.

For wind turbines, such speed is schematized as the apparent wind vector Vr (vectorial combination of external wind Vv and blade advance speed Vp); therefore, Re has very low values when Vr is low, i.e. when the components thereof are low.

However, being Vp=TSR×Vv, it follows that the TSR of micro HAWTs must be very high, particularly in low-wind conditions.

Moreover, since Vp is variable with the radius, in the case of HAWTs it is clear that, if the wing chord is kept constant, and assuming that Vv is constant, Re will take all values comprised between 0 (ideally at the axis of rotation of the turbine) and its maximum value, reached at the wing tip, which is the fastest section (Vp=ωR).

Of course, such a situation is not energetically sustainable, and for this reason the blades of HAWTs do not have a constant chord along the radius, but their chord increases gradually from tip to root, for the purpose of keeping Re as constant as possible in all the various profile sections.

As already explained, an aerofoil has a different polar for each value of Re, and within the scope of HAWTs the reference polars are those that are obtained at relatively low values of Re.

The polar represents the behaviour of the profile as the angle of attack α changes, and every profile has a value of α that optimizes its aerodynamic behaviour (i.e. that maximizes the Cl/Cd ratio) for that specific Re value.

Therefore, in addition to Re, as explained above, also the angle α plays a major role in achieving the highest overall efficiency of a HAWT.

Ideally, for an HAWT to express its best aerodynamic efficiency, its blade should maintain, in every section and for any value of Vr, the optimal angle of attack of the chosen profile for that fluid speed.

However, the speed triangle shows that the angle of attack α, assuming that Vv is constant, decreases linearly from the centre towards the periphery as Vp increases.

This is the reason why the blades of horizontal-axis wind turbines are twisted, i.e. their cross-sections form angles with the direction of incidence of the external wind Vv which decrease from centre to periphery, so as to follow the rotation of the vector Vr and keep the value of α as close as possible to the optimal one.

In summary, horizontal-axis micro wind turbines have fixed single wing profiles and are designed to optimize the aerodynamic behaviour of the wing in certain operating conditions, ideally by proceeding as follows:
the nominal TSR value for the turbine is established on the basis of its geometry, rpm, electric coupling, etc. (it is typically a high value to ensure Re values sufficient to cause the profile to work in an aerodynamically satisfactory manner);
given the TSR, the solidity that permits obtaining such value is known, and it is therefore possible to define the architecture of the turbine (number of blades and size thereof);
the nominal TSR having been set, also the value of the design angle of attack α is known, and so is the intensity of the vector Vr as Vv varies;
therefore, being Vr and the wing chord known, the Reynolds number of the profile in the various wind conditions Vv is also known;
by analyzing the polars (concerning the identified Re values), a profile is chosen which, for the selected design value of α, will maximize the Cp of the turbine—the wing is developed in such a way that in every section thereof the angle of attack with Vr will be close to the design value of α. However, this reasoning is effective only under the assumptions that:
TSR stays within values close to the optimal one in all wind conditions (for a to remain constant).
the external wind Vv blows constantly without bursts, i.e. without sudden oscillations in intensity and direction (which would vary the value of α).

In reality, however, Vv is all but constant in intensity and direction, since it oscillates continually, and as a consequence also Vr changes instantly in intensity and direction, so that the blade, designed to work at a given TSR and with a precise value of the angle of attack, must deal with continually changing angles of attack that may depart considerably from the design value.

This produces a loss of aerodynamic efficiency and a lower TSR, resulting in the value of α deviating even further from the design one, until the profile stalls and Cp drops sharply.

This is even truer the lower the value of Vv, because in these conditions Re is very low and the profile, which is already in low-efficiency conditions, will rapidly stall.

As a consequence, prior-art micro HAWTs have high cut-in wind values and actual efficiencies comparable with the design ones only for power values close to the nominal one, but much lower efficiencies in low-wind conditions.

As broadly explained, in order to obtain good efficiency (high Re) it is necessary to have a high TSR; as a consequence, the profiles must pass through the fluid at very high speed, with all the resulting adverse repercussions previously highlighted in terms of structure, dangerousness, environmental impact and noise.

Since high TSRs can only be obtained by keeping solidity low, two-bladed turbines have of course higher efficiencies; however, as solidity decreases, the self-starting capability of the turbine decreases as well, and this is the reason why they are less common than three-bladed turbines, which represent the best trade-off among efficiency, performance and safety.

A further element that differentiates the turbine of the present invention from all prior-art micro HAWTs is related to this very aspect.

The proposed turbine has only two blades (each one made up of a pair of cooperating large-surface profiles) arranged in diametrically opposite positions: it therefore has the same appearance as a two-bladed turbine and the same good qualities thereof (primarily small dimensions and visual impact), without however suffering from its drawbacks (high cut-in wind, extremely high TSRs, excessive noisiness and dangerousness).

The large wing surface ensures high Re values even at revolution speeds (and hence TSRs) considerably lower than those of prior-art turbines.

Moreover, the cooperation between the two profiles, their shape, and their mutual positioning ensure constant efficiency notwithstanding the continual oscillations of the wind.

Finally, the particular cooperation between the wing root and the hub ensures high torque and self-starting capability in any wind condition, i.e. with minimal cut-in wind.

The turbine of the present invention belongs to the family of Downwind HAWTs; while offering an advantage in dimensional terms (absence of a directional tail), this architecture has a two-fold disadvantage in terms of aerodynamic efficiency because the flow is disturbed by:
the shadow effect of the supporting structure
the presence of the hub (part of the wind blows against the blades only after having crossed the hub). The proposed turbine also solves the problems suffered by this family by envisaging:
a supporting structure that is appropriately spaced apart from the blades and the aerodynamic features, so as to limit as much as possible its disturbing action
a hub specially studied for performing a definite active aerodynamic function, which, as previously explained, allows it to convey and accelerate the flow towards the blades (so as to make it capable of producing, instead of absorbing, energy).

Therefore, the proposed turbine turns out to be the only horizontal-axis micro aerogenerator capable of:
ensuring high efficiency even in very small turbines with a downwind architecture;
producing very low noise, although it has the typical architecture of two-bladed turbines.

The appearance similar to a two-bladed downwind turbine allows it to have dimensions and a visual impact that are not even comparable with those of any prior-art horizontal-axis wind turbines currently on the market, which have, in the corresponding sizes, at least three blades and a stabilizer tail.

This architecture makes them highly visually impacting due to the big tail, and very large because the blades and the tail develop in two mutually orthogonal planes, so that, in case of mobile applications, they need to be partially disassembled to be stored after use.

On the contrary, the turbine of the present invention has no tail and, having just two blades, is very transparent to the eye, whether stationary or in motion; in addition, its dimensions are very small and it can be easily stored in a bag or any other container by simply turning the blades to align them with the supporting structure.

This makes it perfect for all those mobile applications where storage after use is needed, e.g. on boats or caravans; the smallest sizes can even be comfortably carried in a rucksack for use while trekking or camping.

In summary, the proposed wind turbine solves all the problems that afflict HAWTs, particularly the smallest ones:
Lower optimal TSR, and hence less noise.
High propulsive torque, resulting in a flat power curve and simple electric coupling.
Self-starting capability even with relatively low solidity and only two blades diametrically aligned with each other (each one composed of two cooperating profiles).
Ability to always collect maximum energy even in variable wind conditions.
Ability to exploit very light winds, due to the considerable breadth of the wing surfaces (extremely low cut-in values).
Very small size and low visual impact.

The relatively low revolution speed produces further benefits that are not directly connected with functionality:
Reduced dangerousness of the machine.
Braking simplicity—Bird-friendliness.

A reduced TSR also ensures an additional advantage, which may seem to be of not much importance, but which is actually non-negligible in respect to the overall performance of a wind turbine. According to aerodynamic analysis, the faster the object the greater the impact of its shape and surface finish.

When the aerogenerator is operating outdoors, the blades get inevitably contaminated by pollution and atmospheric agents, and this may change the shape of the blades and will most certainly affect their surface finish.

In terms of energy production, even though this type of variation may be only marginal, it nonetheless has a non-negligible impact.

Being characterized by a low TSR, the wind turbine of the present invention is less sensitive to variations in shape and surface finish that may be caused by pollution and atmospheric agents.

In one exemplary embodiment, the horizontal-axis wind turbine comprises a supporting structure (hub) rotating about a central axis.

The blades are rigidly connected to the hub to rotate about the central axis along an operating trajectory, in a direction of rotation.

Said blades are each made up of a pair of wing profiles, each one defining a head and a tail, wherein the head leads the trail in the direction of rotation and one profile leads the other in the direction of rotation.

The profiles that constitute the blade will be distinguished into wing and deflector or flap.

The deflector is positioned along the operating trajectory, with its tail proximal to the wing head. Between the deflector tail and the wing head there is a gap.

The characterizing and distinctive element of this machine lies in the fact that propulsive thrust derives from the aerodynamic cooperation of the two wing profiles of each blade.

What can be achieved with this configuration is a considerable increase in the propulsive component parallel to Vp of the aerodynamic force being developed, at the expense of the orthogonal component, which is useless for propulsive purposes and detrimental to the structure. The result is that the power produced by the machine is characterized by a significantly higher torque than that expressed by a “traditional” machine, at a significantly lower revolution frequency.

The apparent wind Vr is defined as the wind perceived by an observer integral with the wing in motion, i.e. the vectorial combination of the actual wind Vv and the wing advance speed Vp, inverted in sign.

The profile chord C is defined as the straight line that connects the front end to the rear end of a wing profile.

The angle of attack α is defined as the angle formed by the apparent wind direction with the profile chord.

Lift is defined as the aerodynamic force orthogonal to the apparent wind direction, and drag is defined as the force acting upon the profile in the apparent wind direction.

Aerodynamic stall is defined as the phenomenon caused by the detachment of the fluid vein from the extrados of an aerofoil, which occurs beyond a given angle of attack and progressively increases, causing loss of lift and increased drag.

When these concepts are applied to a single wing moving relative to the wind, one obtains that the profile will not stall on condition that its speed Vp is very high compared to that of the wind Vv.

The necessary condition is that the vectorial composition of the two speeds Vr generates an angle of attack α not exceeding 8-12°.

In other terms, being TSR=Vp/Vv, an aerofoil will not stall only for TSR values greater than 4-6.

In our case, stall does not occur even for much lower TSR values, because the blade is made up of a pair of cooperating profiles, wherein the leading one (deflector) performs the task of deviating the flow onto the trailing one, keeping the angle of attack thereon within optimal values.

The presence of the deflector ahead of the wing causes the fluid threads to be deflected towards it and to remain attached thereon through the Coanda effect, thus avoiding the stall phenomenon.

On the other hand, the shape of the deflector is such that it can work with good efficiency and without stalling even at rather high and variable angles of attack, so as to ensure considerable “drive” in a broad range of conditions.

Should it nevertheless reach the stall condition, it would still perform its “deflector” function, i.e. it would continue deflecting the flow onto the wing, allowing it to operate in optimal conditions at all times.

The result is that the pair of cooperating profiles will never stall, and the blade composed of deflector+wing will always collect as much as possible of the available energy, also when the speed and direction of the wind change.

This also happens when the device (inverter, battery charger, or the like) used for adjusting the power requested to the machine in relation to the force of the wind is not optimized as a function of the characteristic curve of the machine itself.

This phenomenon is also exploited during the starting phase, when the deflector+wing system is also able to convey bursts and to ensure starting torque, thus making the machine self-starting even in low-wind conditions.

This type of performance cannot be obtained from machines with single profiles, since they cannot instantly and adequately adapt themselves to the variability of the wind, whose sudden variations in direction and intensity lead to the stall phenomenon because the wing is not working within the design speed and angle range.

In such machines, this implies starting difficulty and loss of efficiency during the transients, resulting as a whole in lower energy production.

In one exemplary embodiment, the turbine is equipped with an elastic hinge along the supporting pole.

There is a reference limit value for the revolution speed of the turbine, beyond which it, or some parts thereof, are at survival risk.

Such value depends on the dimensions and structural characteristics of the turbine itself; when exceeded, it is necessary to slow down or even stop the turbine.

When said speed limit is reached, thanks to an elastic hinge suitably calibrated according to the component of the aerodynamic forces that is parallel to the direction of the external wind, the proposed turbine rotates in the plane defined by the axis of rotation and the axis of the supporting pole, taking a configuration that is no longer aerodynamically correct because the disk defined by the turning blades loses orthogonality with the direction of the external wind and tends to move parallel thereto.

The resulting energy dissipation will slow down the turbine and prevent it from reaching critical speeds.

In a non-limiting example, the preloaded elastic component comprises a preloaded spring, the preload of which corresponds to a given overturning force generated by the blades, which, when exceeded, will cause said spring to start compressing, thereby allowing the turbine to rotate.

The present invention relates to a horizontal-axis turbine for a wind generator, the turbine comprising a hub and two opposed blades, the turbine being characterized in that:
said hub is adapted to be directly or indirectly connected to a supporting pole of the wind generator, and comprises a rotary part, to which said two blades are connected;
said two blades are elongate in a longitudinal direction operationally orthogonal to the central axis of rotation A of the turbine;
each one of said two blades comprises a wing and a deflector fixedly connected to said rotary part, the wing and the deflector having a head and a tail, the deflector tail being proximal to the wing head;
the deflector is positioned ahead of the respective wing with respect to the direction of rotation of the turbine, so as to deflect the air flow towards the wing;
the tail of each deflector is spaced apart from the head of the respective wing, so as to define a gap between the deflector and the wing;
the wing and the deflector of each one of said two blades are connected at their outermost ends by a connection element.

The present invention also relates to a wind generator comprising said turbine, the generator comprising:
a rigid supporting tube adapted to be connected, at a first end thereof, to a fixed part of the hub, said fixed part being connected to said rotary part;
an electromagnetic generator directly or indirectly connected to a second end of said supporting tube and to said supporting pole;
an elastic metal cable inside the supporting tube, adapted to transfer the rotation of said rotary part M2 to said electromagnetic generator.

It is a particular object of the present invention to provide a horizontal-axis turbine for a wind generator and a wind generator comprising said turbine as described in detail in the claims, which are an integral part of the present description.

### BRIEF DESCRIPTION OF THE DRAWINGS

These features will become more apparent in the light of the following descriptions of some preferred embodiments, illustrated merely by way of non-limiting example in the annexed drawings, wherein:

FIGS. 1 and 2 illustrate vectorial graphs showing the trends of the forces involved in prior-art turbines;

FIGS. 3 and 4 illustrate graphs showing the trends of the most important parameters in prior-art turbines;

FIG. 5 shows the trends of the Cp parameter as a function of the TSR parameter for different types of known turbines;

FIG. 6 shows a perspective view of a first variant of a wind turbine according to the invention;

FIG. 7 shows a perspective view of a second variant embodiment of the wind turbine according to the invention;

FIGS. 8 and 9 show perspective views of a third variant embodiment of the wind turbine according to the invention;

FIG. 10 shows vectorial graphs that illustrate the trends of the forces involved in the turbines of the invention.

In the drawings, the same reference numerals and letters identify the same items or components.

### DETAILED DESCRIPTION OF SOME PREFERRED EMBODIMENTS OF THE INVENTION

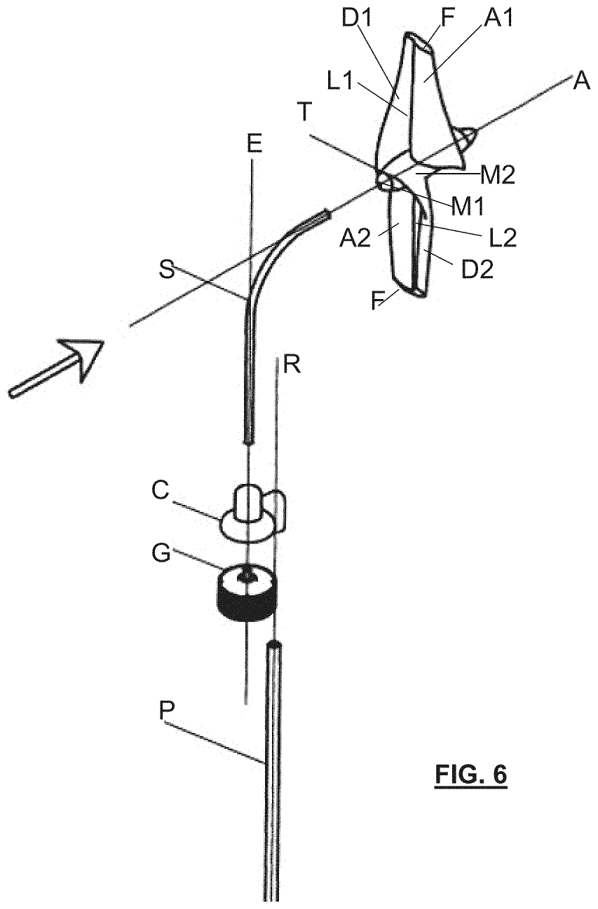

With reference to FIG. 6, the following will describe a first generic and non-limiting exemplary embodiment of the turbine proposed herein, which has two blades and respective deflectors.

In FIG. 6, T designates a turbine for a wind generator having its axis parallel to the wind direction (indicated by an arrow), configured for transforming kinetic energy of an air mass in motion (i.e. kinetic energy of the wind) into mechanical energy in the form of output of propulsive torque at a given revolution frequency through a suitably supported shaft.

The turbine T comprises two opposed blades, elongated in a longitudinal direction operationally orthogonal to its central axis of rotation A.

The blades are connected to a supporting hub M to rotate about the central axis A.

Each blade comprises a wing (A1, A2) and a deflector or flap (D1, D2) fixedly connected to the hub.

The wing and the deflector have a head and a tail. The deflector tail is proximal to the wing head; the deflector is in a position ahead of the wing with respect to the direction of rotation of the turbine, so as to deflect the air flow towards the wing.

Preferably, the tail of each deflector is spaced apart from the head of the respective wing to define a gap (L1, L2) between the deflector and the wing.

Preferably, the aerofoil of each wing and each deflector is biconvex. The wing and the deflector of the blade are connected at their outermost ends by a connecting element F, e.g. of the winglet type.

In the example of embodiment shown in FIG. 6, unlike most prior-art turbines, the electromagnetic generator G is outside the turbine body.

In this non-limiting example, the electromagnetic generator G is arranged at the base of a rigid supporting tube S, forming a 90-degree bend relative to the supporting pole P, so that it can be moved away from the blades in order to reduce its shadow effect on the turbine.

The choice of moving the generator away from the turbine body provides multiple advantages: extremely small hub dimensions, resulting in greater wing extension for the same swept area the turbine is very light, and therefore the terminal part of the supporting tube (from generator to turbine) can be very slim and have a curved shape (reduced shadow effect).

For applications wherein the turbine must rotate about an axis R, e.g. coinciding with the axis of the supporting tube S, in order to align its axis of rotation A with the wind direction, the generator G is connected to the supporting pole P through an interface C that allows the turbine+generator assembly to rotate about the axis R and orient itself in the wind direction. The generator G is cantilevered relative to the supporting pole P.

The assembly composed of the turbine T, the supporting tube S, the interface C and the electromagnetic generator G constitutes a balanced system in terms of gravitational inertial forces, as far as the rotation about the axis R is concerned, thus ensuring that the system will only rotate because of the effect of aerodynamic actions.

At its base, the supporting tube S is rigidly fitted to the interface C, which in turn is rigidly fixed to the electric generator G.

At the upper end, the supporting tube S is rigidly fitted to the front part of the hub M of the turbine T.

The hub M comprises a fixed part M1, connected to the tube S, and a rotary part M2, to which the blades are connected.

The fixed hub portion M1 is connected to the rotary part M2 by means of, for example, a bearing system.

In one possible embodiment, the rotary motion of the turbine T about the axis A is transferred to the shaft of the generator G, which rotates about an axis E, by means of an elastic metal cable inside the supporting tube S, rigidly fixed at its ends to the turbine T and to the shaft of the electromagnetic generator G. The cable may be a twisted steel-wire cable, a spring cable, etc.

In this non-limiting example, the axis A and the axis E run in orthogonal directions.

As a consequence, the axis E and the axis R are parallel to each other and have some eccentricity necessary for balancing the above-mentioned inertial masses.

The supporting tube S is substantially L-shaped, with a first part aligned with the axis of rotation A of the turbine, a second part aligned with the axis of rotation E of the electromagnetic generator G, and a curved central connecting part.

Within the connection interface C there are a system, coaxial to R, which allows the rotation of the assembly T-S-C-G about the axis R, and a rotary contact for the electric transfer of the produced current from the electromagnetic generator G to the electronic management system (not shown). The system is, for example, a bearing system.

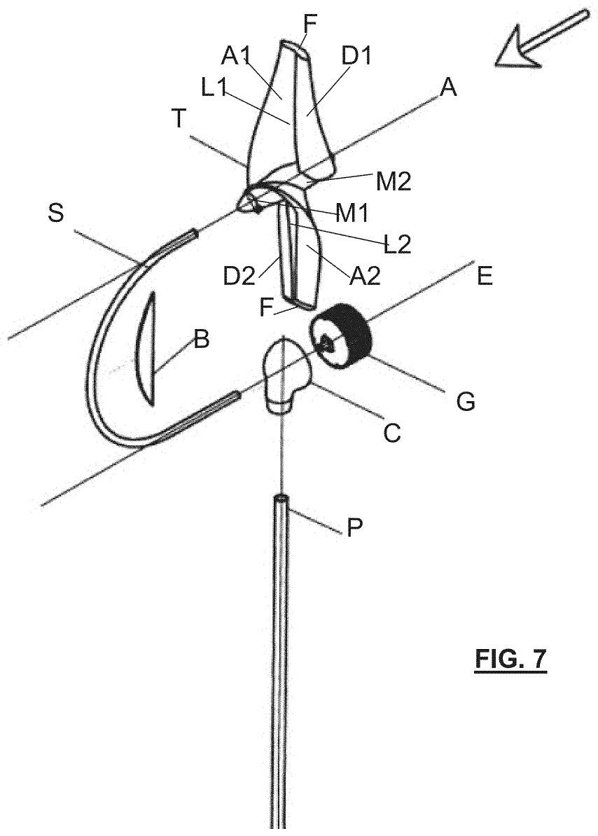

In an implementation variant, as shown in FIG. 7, the axes E and A are parallel, and therefore the rigid supporting tube S has two parallel sections joined by a 180-degree central part, one section being connected to the fixed part M1 of the hub and the other section being connected to the interface C. In a preferred embodiment, this variant envisages that the supporting tube S supports the turbine T from behind, not from the front. In this case, the fixed hub portion is the rear one, not the front one, with respect to the wind direction, and the turbine takes the UPWIND configuration. In this case as well, the generator G is cantilevered relative to the supporting pole P.

The supporting tube S is substantially U-shaped, with a first part aligned with the axis of rotation A of the turbine, a second part aligned with the axis of rotation E of the electromagnetic generator G, and a curved central connecting part. In this variant, the supporting tube S may therefore be equipped with a stabilizer vane B, preferably applied to the curved central part.

A common feature of all the non-limiting variant embodiments described above is that the electromagnetic generator G, which is the heavy part, is moved away from and positioned lower than the turbine, and is directly connected to the supporting structure.

In a variant embodiment, the turbine of the invention can be installed in a fixed position, i.e. without the possibility of rotating about an axis R to remain aligned with the wind, and therefore without the connection interface C.

This solution can be adopted whenever the turbine is inserted in an environment where the flow is strongly characterized by a dominant direction, e.g. in a tunnel, or between two walls channelling the flow; in such a case, the generator may be rigidly fixed to the existing structures, without the necessity of providing rotary contacts and inertial mass balancing.

In the example described herein, the rotary motion is transferred from the axis A to the axis E directly by means of the flexible cable; such transfer may also be effected by means of bevel gear pairs and a rigid shaft, or by any other per se known means.

In a further example of embodiment it is possible to decouple the rpm of the turbine T from the rpm of the generator G by adding a transmission connecting the axes A and E, which may be made in any per se known manner, e.g. by using a transmission belt, gears, bevel gear pairs, etc.

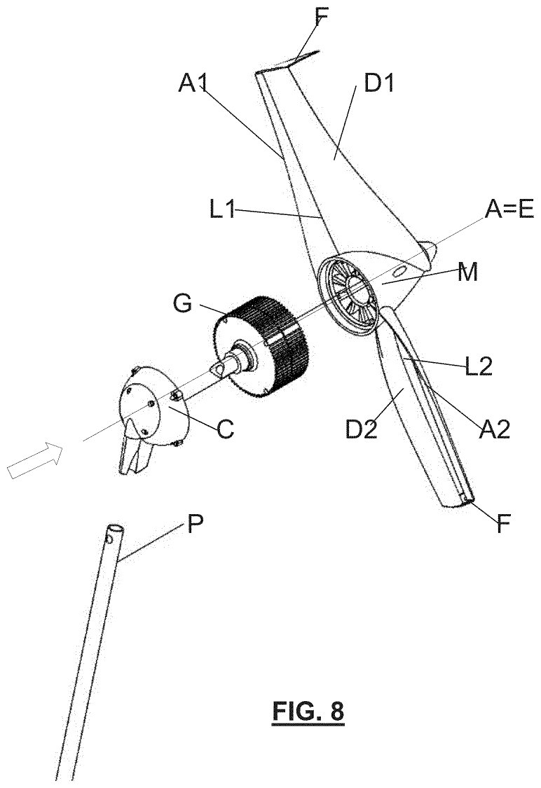

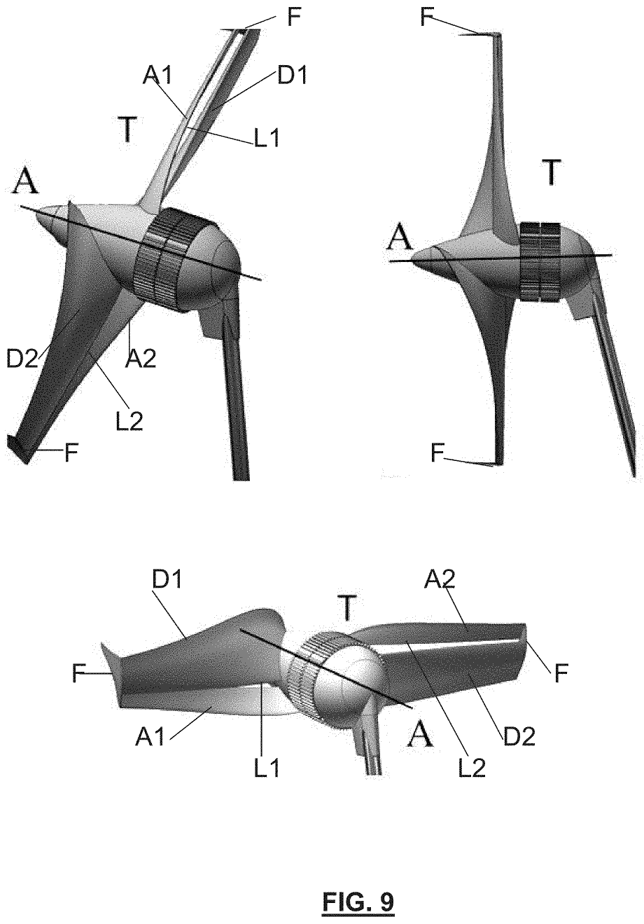

In a further embodiment, as shown in FIGS. 8 and 9, the electromagnetic generator G is in axis with the turbine T, connected to the hub between the fixed part M1 and the rotary part M2. Therefore, the axis of rotation A of the turbine coincides with the axis of rotation E of the generator shaft. The fixed part M1 of the hub is fixed to the supporting pole P, and the rotary shaft of the generator directly supports the turbine T.

In the above-described variants, the hub preferably has a biconvex shape defined by the revolution of an aerofoil.

The deflector and the wing preferably have a biconvex section, defined by a wing profile, and a development characterized by a twist, such that the sections of both profiles are rotated, considering two different diametrical positions, in particular, for example, the one proximal to the hub and the terminal one. Also the chord, i.e. the aerofoil length that defines each section of the deflector and of the wing, has a dimension that is greater near the hub and decreases progressively (according to a definite mathematical law) towards the outside of the turbine, being at its minimum at the outermost end (section corresponding to the turbine diameter).

The shape is determined on the basis of the following considerations.

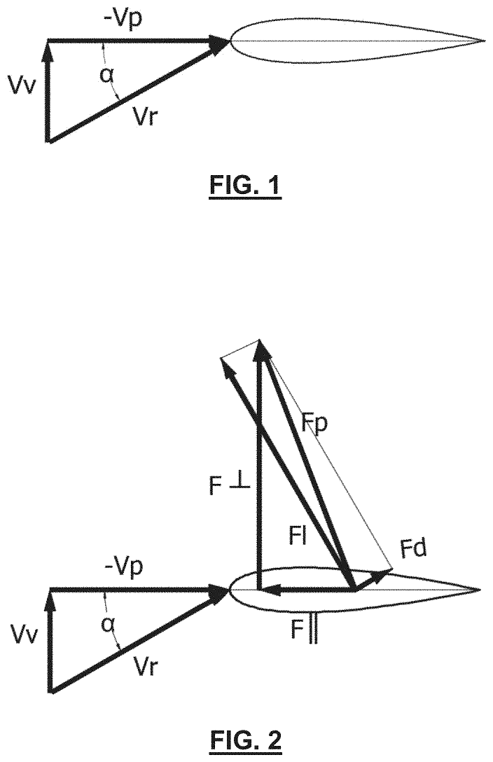

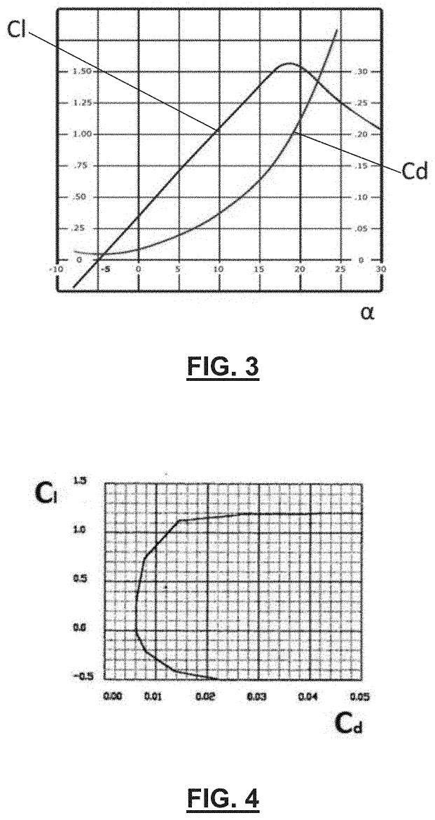

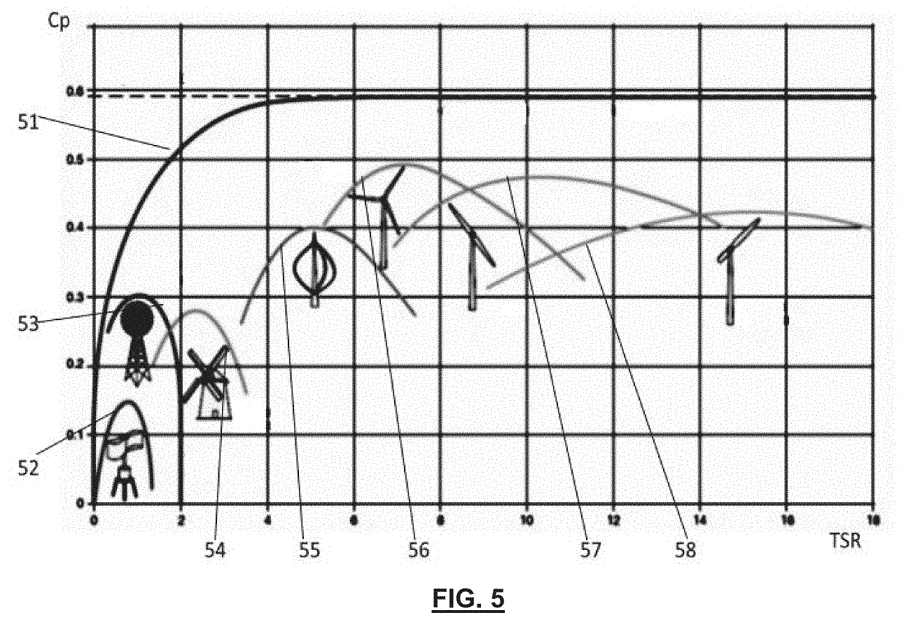

With reference to FIG. 1, since Vp (profile speed) is variable with the radius, it is clear that, if the profile chord is kept constant, and assuming that Vv (external wind speed) is constant, the Reynolds number Re (which is directly proportional to both the profile speed and the profile chord) will take all values comprised between 0 (ideally at the axis of rotation of the turbine, where Vp=0) and its maximum value, reached at the wing tip, which is the fastest section (Vp=ωR).

As previously explained, in order to maximize the efficiency of wind turbines it is necessary to keep Re as constant as possible throughout the profile sections, and therefore the blades of HAWTs cannot have a constant chord along the radius, but must have a chord that increases from the tip towards the root, for the purpose of keeping Re as constant as possible in the various profile sections (Vv being equal).

Moreover, for a HAWT to express its best aerodynamic efficiency, its blade should ideally maintain, in every section and for any value of Vr (apparent wind vector), the optimal angle of attack α of the chosen profile for that fluid speed (identified by vector Vr).

However, the speed triangle of FIG. 1 shows that the angle of attack α, assuming that Vv is constant, decreases linearly from the centre towards the periphery as Vp increases.

This is the reason why the blades of horizontal-axis wind turbines are twisted, i.e. their cross-sections are rotated, considering two different diametrical positions, forming angles with the direction of incidence of the external wind Vv which decrease from the centre to the periphery, so as to follow the rotation of the vector Vr and keep the value of α as close as possible to the optimal one.

The above-described non-limiting examples may be subject to further variations without however departing from the protection scope of the present invention, including all equivalent embodiments known to a man skilled in the art.

The elements and features shown in the various preferred embodiments may be combined together without however departing from the protection scope of the present invention.

From the above description, those skilled in the art will be able to produce the object of the invention without introducing any further construction details.

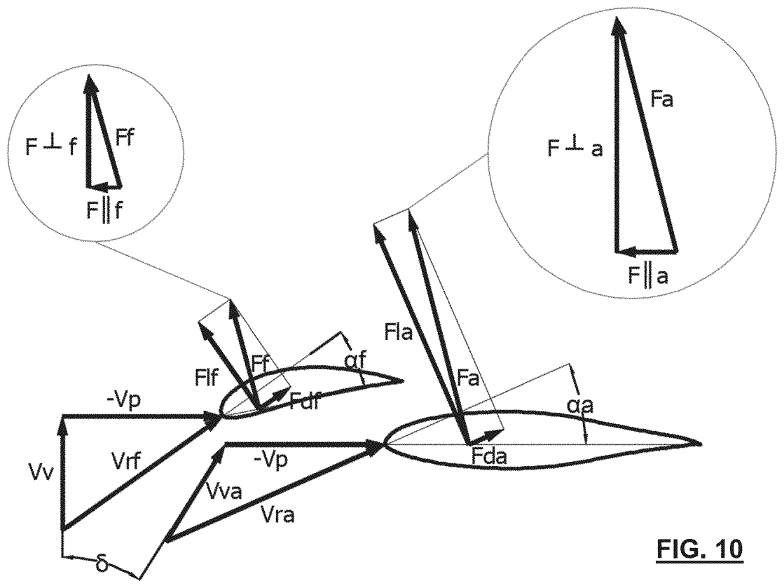

The following will describe the behaviour of the system in physical terms with reference to FIG. 10.

In FIG. 10, speeds and forces are described in vectorial terms.

### Symbols:

Vp blade advance speed
Vv absolute external wind speed
Vrf apparent wind on the flap
Vva absolute speed of the wind on the wing after the deviation generated by the flap
Vra apparent wind on the wing
Flf aerodynamic lift of the flap
Fdf aerodynamic drag of the flap
Ff resultant of the aerodynamic forces on the flap
F∥f propulsive component of the aerodynamic force of the flap, parallel to Vp
F⊥f detrimental component of the aerodynamic force of the flap, orthogonal to Vp
Fla aerodynamic lift of the wing
Fda aerodynamic drag of the wing
Fa resultant of the aerodynamic forces on the wing
F∥a propulsive component of the aerodynamic force of the wing, parallel to Vp
F⊥a detrimental component of the aerodynamic force, orthogonal to Vp
αf angle of attack of the apparent wind on the flap
αa angle of attack of the apparent wind on the wing
δ angle of deviation of the actual wind produced by the flap

For each blade section (wing+flap), it is possible to draw speed and force triangles similar to this, with different values of Vp (increasing from the root towards the tip of the blade), but always, assuming that Vv is constant, with the same αf and αa.

Vv is the actual wind speed. The blade section taken into consideration is moving at a speed Vp. By vectorially summing up such speeds, one obtains the apparent speed of the wind on the flap Vrf. Such speed, according to the known aerodynamics principles, generates on the flap a force Ff that is the vectorial resultant of the lift Flf (orthogonal to Vrf) and the drag Fdf (parallel to Vrf).

As regards the operation of the turbine, it is of interest to break up the resultant of the aerodynamic forces in two other directions:
F∥f component parallel to Vp, and therefore propulsive and usable for energy production;
F⊥f component orthogonal to Vp, useless for propulsive purposes and detrimental to the structures.

The aerodynamic forces are generated through the effect of the angle of attack αf.

The aerodynamic forces generated by the wing are made possible also with a low TSR due to the fact that the angle of attack αa is smaller than αf, through the effect of the deviation of the flow generated by the flap, and takes values smaller than the profile stall values.

The angle αa assumes aerodynamically optimal values in all sections of the wing.

CFD simulations and experimental wind tunnel tests have shown that the wind having an absolute vectorial speed Vv is deviated, through the effect of the presence of the flap, by an angle δ and takes the vectorial value Vva. The wing that follows the flap therefore meets the air flow at the apparent speed Vra, which is the vectorial summation of Vva and (−Vp). The angle of attack of Vra on the wing is αa. This angle is smaller than it would without the presence of the flap. On the other hand, if the angle αa exceeds the stall value, the wing profile will produce no lift and will lose propulsive force. Therefore, two components are consequently generated for the wing as well:
F∥a component parallel to Vp, and therefore propulsive and usable for energy production;
F⊥a component orthogonal to Vp, useless for propulsive purposes and detrimental to the structures.

The importance of the present invention lies in the behaviour that will now be described.

The presence of the flap permits each one of two profiles to mutually benefit from the presence of the other (cooperating profiles).

Such cooperation is not only fluid-dynamic, but also structural.

In fact, the two profiles (wing and flap) are connected at their ends by a bridge that, in one possible embodiment, may have winglet characteristics.

In aerodynamics, a winglet is defined as a wingtip device used for improving the aerodynamic efficiency of a wing by reducing the induced drag caused by wingtip vortices.

It is an orthogonal or angled extension of the tip, and produces an effect similar to wing elongation, i.e. a reduction in the intensity of wingtip vortices, with a consequent increase in the aerodynamic efficiency of the wing.

In the proposed turbine, the connection between the wingtips and the deflector creates a closed structure, which considerably improves the blade's capability to withstand the stresses that are generated during the operation of the turbine, thus improving its inherent safety.

The wing can be efficient (it never enters the stall condition) even at low peripheral speeds when the angles of attack increase, thanks to the presence of the flap that adequately adjusts the angle of attack. By appropriately choosing the best profiles for the wing and the flap, their proportions and their mutual positioning, along with the architecture of the wing and the hub and their cooperation in the central part of the turbine, it is possible to maximize the aerodynamic efficiency of this machine. Such efficiency is always maintained, even in highly variable wind conditions, because the flow that hits the blade has always the same direction, independently of the absolute external wind conditions, due to the deflection generated by the flap.

The result is a machine with considerable propulsive torque in any wind condition, which can therefore be used at much lower TSRs than any prior-art HAWT, to advantage of quietness and safety. This latter aspect is also guaranteed by the architecture of the machine itself, which is characterized by strong blades having a very large root and therefore firmly connected to the hub, made up of two profiles connected together also at their ends, which ensure a box-like behaviour of the blade and make it stiff and light.

This latter aspect is of fundamental importance for safety purposes, because light wings hugely reduce the centrifugal forces and hence the stresses undergone by the structure as a whole.

In order to be able to attain this result in terms of lightness and mechanical performance, it is necessary to adopt an innovative construction technology capable to ensure such a result while at the same time complying with the low production cost requirements imposed by the market of very small micro wind turbines, with an output of the order of hundreds of Watts.

This is an extremely crowded market, characterized by low production costs and very large volumes, requiring production facilities capable of ensuring such large volumes.

One technology that could be used to ensure great lightness combined with high mechanical performance is the technology of composite materials.

Such technology, however, wherein the human labour component is still very important, places strong limitations on productivity.

On the other hand, given the particular architecture of the turbine, it would also be difficult to implement the classic technology that envisages the injection of charged plastic polymers into moulds, which would be extremely expensive and complex.

Therefore, a modern technology has been selected, which closely follows the innovation character of the turbine itself.

3D printing is, at present, the optimal solution for obtaining complex, biomorphic shapes like those of the turbine proposed herein.

By means of a powerful computer and software capable of executing parametric modelling operations, it is possible to create a three-dimensional model having sinuous shapes such as those that characterize the turbine, in compliance with all of the above aspects.

To obtain the turbine, it is then sufficient to print this model in the most appropriate material by using suitable three-dimensional printers.

This system has no productivity limitations, since it is sufficient to purchase the necessary number of printers to obtain the required number of machines, and ensures full versatility for changing shapes and dimensions at no expense, which would be impossible to do with any other traditional technology, which would inevitably require new physical models and moulds.

Furthermore, the 3D printing technology offers an additional advantage, which is impossible to obtain, for example, with injection.

A wing profile printed by 3D technology may have different structures and material in different places to meet variable structural or finishing needs or requirements of any other nature; for example, in order to obtain an extremely light, but strong, wing, a thick and strong skin may be constructed with very high surface finish and a coarser internal honeycomb texture (to speed up the printing process); also, the quantity of material can be dosed at will, e.g. to obtain a texture that is more dense at the root and less dense at the tip, for higher tensile strength.

A versatile and innovative technology like 3D printing, which is now becoming widespread also for industrial production, and not only for prototyping applications, is currently the best choice for manufacturing the turbine of the present invention.

1. Horizontal-axis turbine for a wind generator, the turbine comprising a hub and two opposed blades, the turbine being characterized in that:
said hub is adapted to be directly or indirectly connected to a supporting pole (P) of the wind generator, and comprises a rotary part (M2), to which said two blades are connected;
said two blades are elongate in a longitudinal direction operationally orthogonal to the central axis of rotation (A) of the turbine,
each one of said two blades comprises a wing (A1, A2) and a deflector (D1, D2) fixedly connected to said rotary part (M2), the wing and the deflector having a head and a tail, the deflector tail being proximal to the wing head,
the deflector is positioned ahead of the respective wing with respect to the direction of rotation of the turbine, so as to deflect the air flow towards the wing,
the tail of each deflector is spaced apart from the head of the respective wing, so as to define a gap (L1, L2) between the deflector and the wing,
the wing and the deflector of each one of said two blades are connected at their outermost ends by a connection element (F).

2. Turbine according to claim 1, wherein said hub has a biconvex shape defined by the revolution of an aerofoil.

3. Turbine according to claim 1, wherein said deflector and said wing have a section defined by a wing profile and a development characterized by a twist, with a chord that defines the profile length having a dimension that is greater at the hub and decreases linearly towards the outside of the turbine, being at its minimum at said connection element (F).

4. Wind generator comprising said turbine according to claim 1, the generator comprising:
a rigid supporting tube (S) adapted to be connected, at a first end thereof, to a fixed part (M1) of the hub, said fixed part being connected to said rotary part (M2);
an electromagnetic generator (G) directly or indirectly connected to a second end of said supporting tube (S) and to said supporting pole (P);
an elastic metal cable inside the supporting tube (S), adapted to transfer the rotation of said rotary part (M2) to said electromagnetic generator (G).

5. Wind generator according to claim 4, comprising an interface (C) between said second end of the supporting tube (S) and said electromagnetic generator (G), said interface (C) being fixedly or rotatably connected to said supporting pole (P), said interface (C) being in a position away from said turbine and cantilevered relative to the supporting pole (P), so as to provide balancing of the weights of said wind turbine generator.

6. Wind generator according to claim 5, wherein said electromagnetic generator (G) has an axis of rotation (E) orthogonal to said axis of rotation (A) of the turbine, and said supporting tube (S) is substantially L-shaped, with a first part aligned with said axis of rotation (A) of the turbine, a second part aligned with said axis of rotation (E) of the electromagnetic generator (G), and a curved central connecting part.

7. Wind generator according to claim 5, wherein said electromagnetic generator (G) has an axis of rotation (E) parallel to said axis of rotation (A) of the turbine, and said supporting tube (S) is substantially U-shaped, with a first part aligned with said axis of rotation (A) of the turbine, a second part aligned with said axis of rotation (E) of the electromagnetic generator (G), and a curved central connecting part.

8. Wind generator according to claim 5, comprising a vane (B) in said curved central part.

9. Turbine according to claim 1, wherein an electromagnetic generator (G) is directly connected to said rotary part (M2).

10. Wind generator comprising said turbine according to claim 2, the generator comprising:
a rigid supporting tube (S) adapted to be connected, at a first end thereof, to a fixed part (M1) of the hub, said fixed part being connected to said rotary part (M2);
an electromagnetic generator (G) directly or indirectly connected to a second end of said supporting tube (S) and to said supporting pole (P);
an elastic metal cable inside the supporting tube (S), adapted to transfer the rotation of said rotary part (M2) to said electromagnetic generator (G).

11. Wind generator comprising said turbine according to claim 3, the generator comprising:
a rigid supporting tube (S) adapted to be connected, at a first end thereof, to a fixed part (M1) of the hub, said fixed part being connected to said rotary part (M2);
an electromagnetic generator (G) directly or indirectly connected to a second end of said supporting tube (S) and to said supporting pole (P);
an elastic metal cable inside the supporting tube (S), adapted to transfer the rotation of said rotary part (M2) to said electromagnetic generator (G).
